(19) United States
(12) Patent Application Publication
(10) Pub. No.: US 2025/0380349 A1
(43) Pub. Date: Dec. 11, 2025

(54) MULTICHANNEL PLASMA GENERATION SYSTEM AND METHOD

(71) Applicant: FUSE ENERGY TECHNOLOGIES CORP., San Leandro, CA (US)

(72) Inventors: Vahid DAMIDEH, Québec (CA); Jean-Christoph BTAICHE, Québec (CA); Raymond GOLINGO, Québec (CA)

(73) Assignee: FUSE ENERGY TECHNOLOGIES CORP., San Leandro, CA (US)

(21) Appl. No.: 18/873,678

(22) PCT Filed: Jun. 14, 2023
(86) PCT No.: PCT/US2023/068440

§ 371 Date: Dec. 10, 2024

Related U.S. Application Data
(60) Provisional application No. 63/352,251, filed on Jun. 15, 2022.

(51) Int. Cl. H05H 1/34; H05H 1/44

(52) U.S. Cl. CPC H05H 1/3431; H05H 1/3405; H05H 1/44

(57) ABSTRACT

A plasma generation system for generating a multilayer plasma includes a plasma generator that includes an inner electrode, an intermediate electrode surrounding the inner electrode and defining therebetween an inner plasma channel having an inner plasma outlet, and an outer electrode surrounding the intermediate electrode and defining therebetween an outer plasma channel having an outer plasma outlet; a process gas unit configured to provide a first and a second process gas inside the inner and outer plasma channels, respectively; and a power supply unit configured to energize the first process gas into a first plasma that flows along the inner plasma channel and out through the inner plasma outlet as an inner layer of the multilayer plasma, and to energize the second process gas into a second plasma that flows along the outer plasma channel and out through the outer plasma outlet as an outer layer of the multilayer plasma.

### RELATED PATENT APPLICATION

The present application claims priority to U.S. Provisional Patent Application No. 63/352,251 filed on Jun. 15, 2022, the disclosure of which is incorporated herein by reference in its entirety.

### TECHNICAL FIELD

The technical field generally relates to plasma technology and, more particularly, to plasma generation systems and methods.

### BACKGROUND

Electromagnetic plasma generators, such as plasma accelerators and guns, are used in various applications, such as in nuclear fusion reactors, ion and plasma sources, pulsed plasma thrusters, plasma-matter interactions, and neutron and high-energy photon generation. Conventional electromagnetic plasma generators use the electric field generated by a high-voltage power supply to energize a gas into a plasma, and they rely on the Lorentz force to propel the plasma. Marshall or coaxial plasma guns are examples of electromagnetic plasma generators. A coaxial plasma gun can include a pair of coaxial electrodes defining an annular plasma formation and acceleration region therebetween. The plasma formation process can involve supplying gas in the plasma formation and acceleration region and applying a voltage between the electrodes to ionize the gas into a plasma, resulting in a radial electric current and an azimuthal magnetic field. The interaction between the radial electric current and the azimuthal magnetic field produces an axial Lorentz force that pushes and accelerates the plasma forward along the plasma formation and acceleration region.

Many nuclear fusion approaches can use electromagnetic plasma generators to provide an initial plasma discharge and heating with a view to enhancing fusion reactor efficiency. Non-limiting examples of such fusion approaches include, to name a few, Z-pinch configurations, compact toroidal configurations, tokamak, stellarator, spheromak, field-reversed configurations, field-reversed colliding beams, magnetized target fusion, polywell configurations, magnetic mirror configurations, cusp confinement, compact fusion reactors, and dense plasma focus. For example, in Z-pinch configurations, an electromagnetic plasma generator can be used to produce a plasma column with an axial current flowing through it. The axial current generates an azimuthal magnetic field that radially compresses the plasma column, resulting in an increase of the fusion reaction rate. Z-pinch reactors are attractive due to their relatively simple geometry, absence of magnetic field coils for plasma confinement and stabilization, inherent compactness, and relatively low cost. Conventional Z-pinch reactors suffer from instabilities that limit plasma lifetimes. Recent research has found that stabilization of the plasma with a sheared flow can help reduce these instabilities, opening up the possibility of producing and sustaining stable Z-pinches over longer timescales. Despite these advances, challenges remain in the field of electromagnetic plasma generators for use in Z-pinch-based fusion devices as well as in various other fields and applications.

### SUMMARY

The present description generally relates to plasma generation systems and methods using a multichannel configuration to generate multilayer plasma flows with the possibility for independent control over the properties of the different plasma layers.

In accordance with an aspect, there is provided a plasma generation system for generating a multilayer plasma, the plasma generation system including:
a plasma generator including:
an inner electrode;
   an intermediate electrode surrounding the inner electrode and defining therebetween an inner plasma channel having an inner plasma outlet; and
   an outer electrode surrounding the intermediate electrode and defining therebetween an outer plasma channel having an outer plasma outlet;
a process gas unit including:
   a first process gas system configured to provide a first process gas inside the inner plasma channel; and
   a second process gas system configured to provide a second process gas inside the outer plasma channel; and
a power supply unit including:
   a first power supply system configured to apply a first discharge driving signal to the inner electrode and the intermediate electrode to energize the first process gas into a first plasma and cause the first plasma to flow along the inner plasma channel and out through the inner plasma outlet to provide an inner plasma layer of the multilayer plasma; and
   a second power supply system configured to apply a second discharge driving signal to the outer electrode and the intermediate electrode to energize the second process gas into a second plasma and cause the second plasma to flow along the outer plasma channel and out through the outer plasma outlet to provide an outer plasma layer of the multilayer plasma.

In some embodiments, the plasma generator includes an additional electrode surrounding the outer electrode and defining therebetween an additional plasma channel having an additional plasma outlet; the process gas unit includes an additional process gas system configured to provide an additional process gas inside the additional plasma channel; and the power supply unit includes an additional power supply system configured to apply an additional discharge driving signal to the outer electrode and the additional electrode to energize the additional process gas into an additional plasma and cause the additional plasma to flow along the additional plasma channel and out through the additional plasma outlet to provide an additional plasma layer of the multilayer plasma, the additional plasma layer surrounding the outer plasma layer.

In some embodiments, each of the inner electrode, the intermediate electrode, and the outer electrode tapers radially inwardly in a direction toward the inner and outer plasma outlets.

In some embodiments, each of the first power supply system and the second power supply system includes a pulsed-DC power supply having a capacitor bank and a switch.

In some embodiments, the inner plasma layer and the outer plasma layer have different axial velocities to provide the multilayer plasma with an embedded radially sheared axial flow.

In some embodiments, the inner plasma layer and the outer plasma layer have at least one of different densities, different temperatures, or different velocities.

In some embodiments, the plasma generation system further includes an intermediate electrode insulator configured to provide electrical insulation between an inner electrode section and an outer electrode section of the intermediate electrode, wherein the first power supply system is configured to apply the first discharge driving signal to the inner electrode and the inner electrode section of the intermediate electrode, wherein the second power supply system is configured to apply the second discharge driving signal to the outer electrode and the outer electrode section of the intermediate electrode.

In some embodiments, each of the first process gas and the second process gas includes deuterium, tritium, hydrogen, or helium, or any combination thereof. In some embodiments, each of the first process gas and the second process gas includes xenon, krypton, argon, or mixtures thereof. In some embodiments, each of the first process gas and the second process gas is a neutral gas. In some embodiments, each of the first process gas and the second process gas is a partially or fully ionized gas.

In some embodiments, the first process gas system is configured to supply the first process gas into the inner plasma channel via one or more first gas injection ports formed through the inner electrode, the intermediate electrode, or both the inner electrode and the intermediate electrode; and the second process gas system is configured to supply the second process gas into the outer plasma channel via one or more second gas injection ports formed through the outer electrode, the intermediate electrode, or both the outer electrode and the intermediate electrode.

In some embodiments, the first process gas system includes a first process gas precursor target disposed inside the inner plasma channel, the first process gas system being configured to generate the first process gas inside the inner plasma channel by sputtering of the first process gas precursor target; and the second process gas system includes a second process gas precursor target disposed inside the outer plasma channel, the second process gas system being configured to generate the second process gas inside the outer plasma channel by sputtering of the second process gas precursor target.

In accordance with another aspect, there is provided a method of generating a multilayer plasma, the method including:
providing a first process gas inside an inner plasma channel defined between an inner electrode and an intermediate electrode surrounding the inner electrode;
providing a second process gas inside an outer plasma channel defined between the intermediate electrode and an outer electrode surrounding the intermediate electrode;
applying a first discharge driving signal to the inner electrode and the intermediate electrode to energize the first process gas into a first plasma and cause the first plasma to flow along the inner plasma channel;
applying a second discharge driving signal to the outer electrode and the intermediate electrode to energize the second process gas into a second plasma and cause the second plasma to flow along the outer plasma channel;
allowing the first plasma to flow out of the inner plasma channel to provide an inner plasma layer of the multilayer plasma; and
allowing the second plasma to flow out of the outer plasma channel to provide an outer plasma layer of the multilayer plasma.

In some embodiments, the method further includes providing an additional process gas inside an additional plasma channel defined between the outer electrode and an additional electrode surrounding the outer electrode; applying an additional discharge driving signal to the outer electrode and the additional electrode to energize the additional process gas into an additional plasma and cause the additional plasma to flow along the additional plasma channel; and allowing the additional plasma to flow out of the additional plasma channel to provide an additional layer of the multilayer plasma, the additional plasma layer surrounding the outer plasma layer

In some embodiments, the method further includes configuring each of the inner electrode, the intermediate electrode, and the outer electrode to taper radially inwardly in diameter along a direction toward the inner and outer plasma outlets.

In some embodiments, the method further includes controlling the inner plasma layer and the outer plasma layer flowing out of the inner plasma channel and the outer plasma channel, respectively, to have different axial velocities to provide the multilayer plasma with an embedded radially sheared axial flow.

In some embodiments, the method further includes controlling the inner plasma layer and the outer plasma layer flowing out of the inner plasma channel and the outer plasma channel to have at least one of different densities, different temperatures, or different velocities.

In some embodiments, the method further includes providing an intermediate electrode insulator between an inner electrode section and an outer electrode section of the intermediate electrode, wherein the first discharge driving signal is applied to the inner electrode and the inner electrode section of the intermediate electrode, and wherein the second discharge driving signal is applied to the outer electrode and the outer electrode section of the intermediate electrode.

In some embodiments, each of the first process gas and the second process gas includes deuterium, tritium, hydrogen, or helium, or any combination thereof. In some embodiments, each of the first process gas and the second process gas includes xenon, krypton, argon, or mixtures thereof.

In some embodiments, the method further includes providing the first process gas inside an inner plasma channel includes supplying the first process gas into the inner plasma channel via one or more first gas injection ports formed through the inner electrode, the intermediate electrode, or both the inner electrode and the intermediate electrode; and providing the second process gas inside an outer plasma channel includes supplying the second process gas into the outer plasma channel via one or more second gas injection ports formed through the outer electrode, the intermediate electrode, or both the outer electrode and the intermediate electrode.

In some embodiments, the method further includes providing the first process gas inside the inner plasma channel includes generating the first process gas by sputtering of a first process gas precursor target disposed inside the inner plasma channel; and providing the second process gas inside the outer plasma channel includes generating the second process gas by sputtering of a second process gas precursor target disposed inside the outer plasma channel.

In some embodiments, the application of the first discharge driving signal is initiated after initiating the provision of the first process gas inside the inner plasma channel, and wherein the application of the second discharge driving signal is initiated after initiating the provision of the second process gas inside the outer plasma channel.

In some embodiments, the provision of the first process gas inside the inner plasma channel and the provision of the second process gas inside the outer plasma channel are initiated at the same time, and wherein the application of the first discharge driving signal and the application of the second discharge driving signal are initiated at the same time.

The plasma generation systems and methods described herein may be used in various fields and applications. Non-limiting examples include, to name a few, plasma sources for nuclear fusion reactors, including multistage Z-pinch fusion reactors; pulsed plasma thrusters for nano-satellites; dense plasma focus devices; advanced neutron generators; and plasma-matter interactions and materials.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIGS. 1 to 5 are schematic representations of a conventional Z-pinch plasma generation system at five different stages of the Z-pinch formation.

FIG. 6 is a flow diagram of a method of generating a multilayer plasma, in accordance with an embodiment.

FIG. 7 is a schematic longitudinal cross-sectional view of a plasma generation system for generating a multilayer plasma, in accordance with an embodiment.

FIG. 8 is a schematic front cross-sectional view of the plasma generation system of FIG. 7.

FIG. 9 is a schematic longitudinal cross-sectional view of a plasma generation system for generating a multilayer plasma, in accordance with another embodiment.

FIG. 10 is a schematic longitudinal cross-sectional view of a plasma generation system for generating a multilayer plasma, in accordance with another embodiment.

FIG. 11 is a schematic longitudinal cross-sectional view of a plasma generation system for generating a multilayer plasma, in accordance with another embodiment.

FIG. 12 is a schematic longitudinal cross-sectional view of a plasma generation system for generating a multilayer plasma, in accordance with another embodiment.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for case and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

The expressions “at least one of X, Y, and Z” and “one or more of X, Y, and Z”, and variants thereof, are understood to include X alone, Y alone, Z alone, any combination of X and Y, any combination of X and Z, any combination of Y and Z, and any combination of X, Y, and Z.

Ordinal terms such as “first”, “second”, “third”, and the like, to modify an element does not by itself connote any order, rank, priority, or precedence of one element over another, but are used merely to distinguish one element having a certain name from another element having otherwise the same name.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of ±10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements, but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, fluidic, logical, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description generally relates to plasma generation systems and methods using multiple plasma channels to generate multilayer plasma flows. For example, in some embodiments, the present techniques can provide a double-channel plasma generation system configured to generate a plasma having two independently controlled plasma layers flowing coaxially one around the other. The techniques disclosed herein can be used in various applications that may require or benefit from a plasma generator capable of providing a multilayer plasma with enhanced control over the plasma properties and parameters of the individual plasma layers. The present techniques can find use in various fields and applications including, to name a few, fusion power generation, plasma sources, ion sources, plasma accelerators, neutron and high-energy photon generation, multi-stage pinches, materials processing, plasma focus, pulsed plasma thrusters, and space propulsion.

Non-limiting examples of systems and methods in which the present techniques may be implemented to provide plasma sources are described in the following U.S. Provisional Patent Applications: Ser. No. 63/123,892, filed Dec. 10, 2020; Ser. No. 63/137,987, filed Jan. 15, 2021; Ser. No. 63/140,658, filed Jan. 22, 2021; Ser. No. 63/145,124, filed Feb. 3, 2021; and Ser. No. 63/154,261, filed Feb. 26, 2021; and in the following International Patent Applications: PCT/US2021/062830, filed Dec. 10, 2021, and published as WO 2022/125912 on Jun. 16, 2022; PCT/US2022/012502, filed Jan. 14, 2022 and published as WO 2022/155462 on Jul. 21, 2022; PCT/US2022/013262, filed Jan. 21, 2022 and published as WO 2022/159669 on Jul. 28, 2022; PCT/US2022/014883, filed Feb. 2, 2022, and published as WO 2022/169827 on Aug. 11, 2022; and PCT/US2022/017858, filed Feb. 25, 2022, and published as WO 2022/220932 on Jan. 26, 2023. The contents of each of these documents are incorporated herein by reference in their entirety.

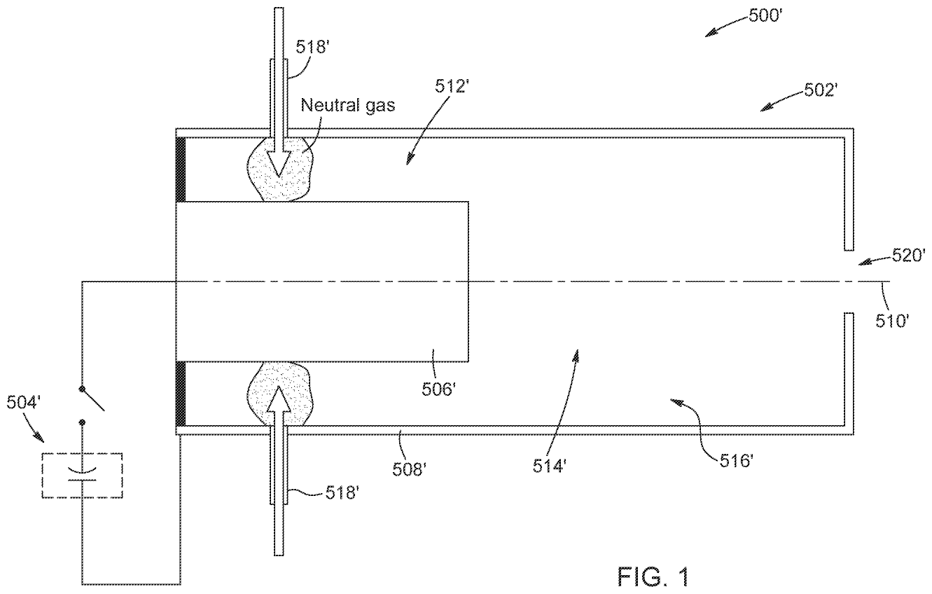

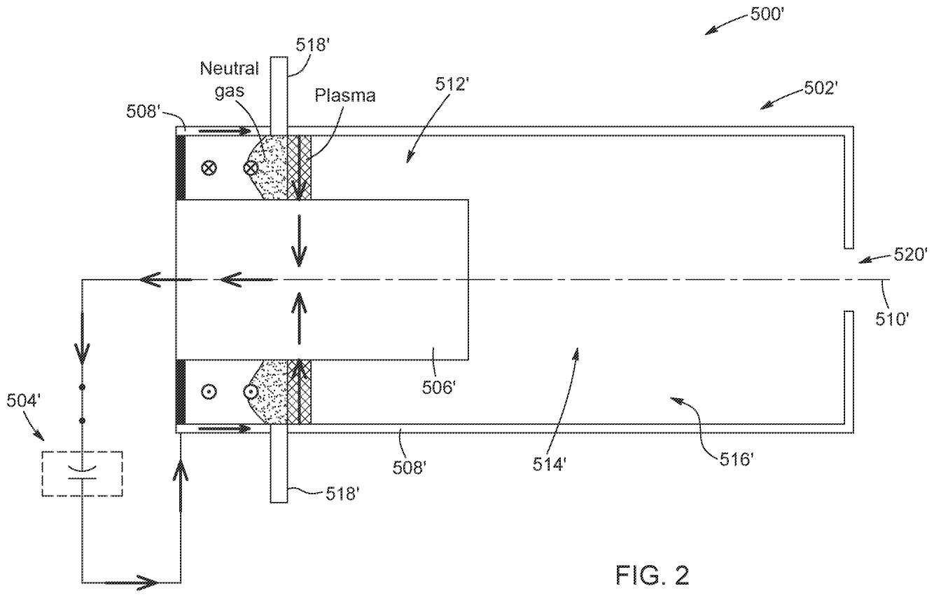

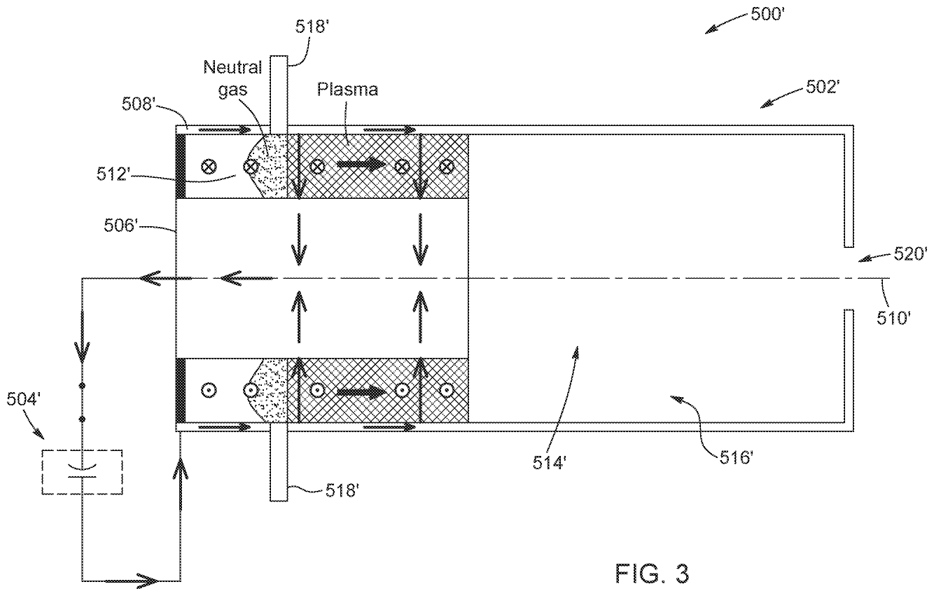

Magnetic plasma confinement is one of several approaches to achieving controlled fusion for power generation. Different types of configurations for magnetic plasma confinement have been devised and studied over the years, among which is the Z-pinch configuration. Referring to FIGS. 1 to 5, there are provided schematic representations of a conventional Z-pinch plasma generation system 500′ at different stages of the Z-pinch formation. The plasma generation system 500′ includes a plasma confinement device 502′ and a power supply unit 504′ configured to supply power to the plasma confinement device 502′. The plasma confinement device 502′ includes an inner electrode 506′ and an outer electrode 508′. The inner electrode 506′ and the outer electrode 508′ form a coaxial electrode arrangement extending along a longitudinal Z-pinch axis 510′. In the illustrated configuration, the outer electrode 508′ extends longitudinally beyond the inner electrode 506′. The annular volume extending between the inner electrode 506′ and the outer electrode 508′ defines a plasma acceleration region 512′, while the cylindrical volume surrounded by the outer electrode 508′ and extending beyond the inner electrode 506′ defines a Z-pinch assembly region 514′. The plasma acceleration region 512′ and the Z-pinch assembly region 514′ define a reaction chamber 516′ of the plasma confinement device 502′. The formation of a Z-pinch plasma can include injecting neutral gas in the acceleration region 512′ (FIG. 1), and applying, using the power supply unit 504′, a voltage between the inner electrode 506′ and the outer electrode 508′ (FIG. 2). The neutral gas can be injected into the acceleration region 512′ via one or more gas injection ports 518′ of the plasma confinement device 502′ (e.g., formed through the peripheral surface of the outer electrode 508′), the one or more gas injection ports 518′ being connected to a gas supply system including a neutral gas source (not shown). The power supply unit 504′ can include a high-voltage capacitor bank and a switch. The voltage applied between the inner electrode 506′ and the outer electrode 508′ is configured to ionize the neutral gas, resulting in the formation of an annular column or washer of plasma in the acceleration region 512′. The plasma column allows electric current to flow radially therethrough between the inner and outer electrodes 506′, 508′ (FIG. 2). The electric current that flows axially along the inner electrode 506′ generates an azimuthal magnetic field in the acceleration region 512 (FIG. 3).

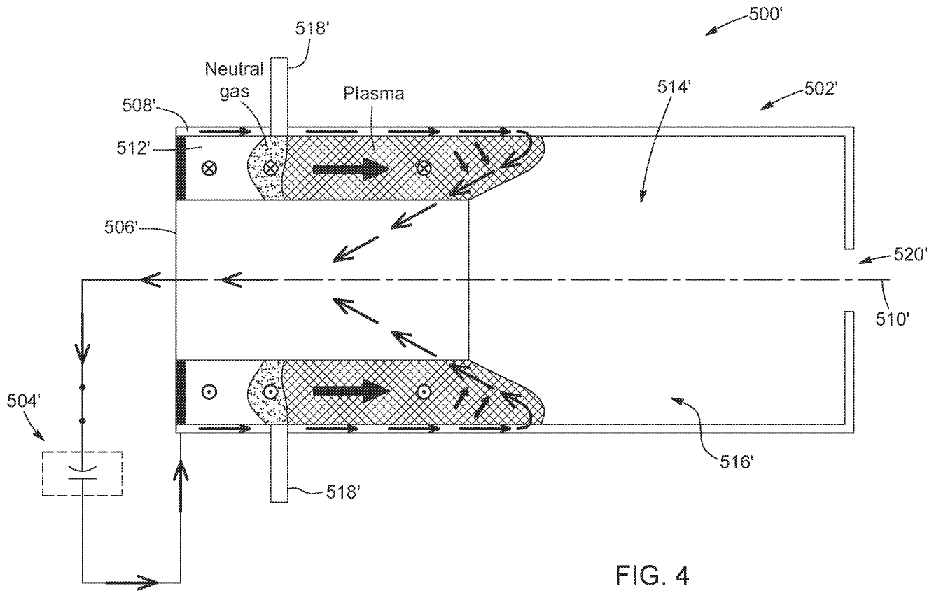

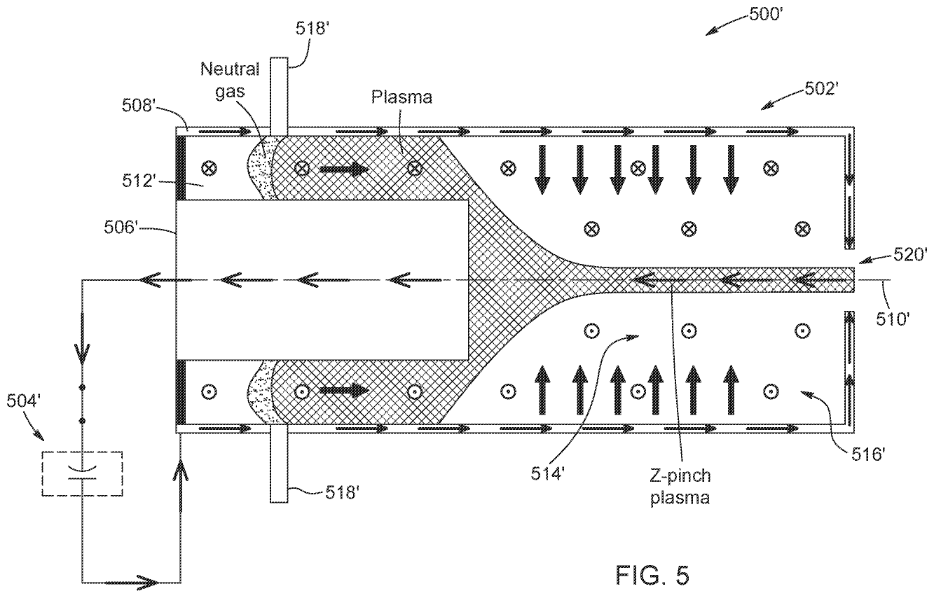

The interaction between the radial electric current flowing in the plasma column and the azimuthal magnetic field produces a Lorentz force in the axial direction that pushes and accelerates the plasma column axially forward along the acceleration region 512′ (FIG. 3) until the plasma column reaches the entrance of the assembly region 514′ and the Z-pinch formation begins (FIG. 4). In the assembly region 514′, the direction of the Lorentz force changes from longitudinal to radially inward, which makes the plasma column collapse inwardly toward the Z-pinch axis 510′ to complete the formation of a Z-pinch plasma (FIG. 5). The axial current flowing in the Z-pinch plasma generates an azimuthal magnetic field that exerts an inward magnetic pressure and an inward magnetic tension, which radially compress the Z-pinch plasma against the outward plasma pressure until an equilibrium is established. In this configuration, the Z-pinch plasma can continue to form and move along the assembly region 514′ for as long as neutral gas is supplied and ionized in the acceleration region 512′. In FIGS. 1 to 5, the plasma confinement device 502′ includes a plasma exit port 520′ configured to allow part of the Z-pinch plasma to exit the plasma confinement device 502′, so as to avoid a stagnation point in the plasma flow that could create instabilities.

By increasing the axial current to compress the Z-pinch plasma to sufficiently high density and temperature, fusion reactions can be achieved within the pinch, resulting in an exothermic energy release. In many applications, fusion reactions release their energy in the form of neutrons. A commonly used fusion reaction is the deuterium-tritium reaction, or D-T reaction, in which the fusion of one deuterium nucleus and one tritium nucleus produces one alpha particle and one neutron. Being chargeless, neutrons can escape from the magnetically confined plasma pinch and transfer their kinetic energy into thermal energy after they exit the confinement region. This thermal energy can be converted into electricity, for example, by transferring the heat generated to a working fluid used by a heat engine for generating electrical energy. The remaining fusion products have kinetic energy that can contribute more energy to the fusion process.

Conventional Z-pinch configurations are unstable due to the presence of magnetohydrodynamic (MHD) instabilities. A challenge in Z-pinch fusion research is devising ways of improving the control over instabilities to keep Z-pinch plasmas confined long enough to sustain ongoing fusion reactions. Techniques such as close-fitting walls, externally applied axial magnetic fields, and pressure profile control have been proposed, with mitigated results. Recent advances have demonstrated that sheared plasma flows—that is, plasma flows with a radius-dependent axial velocity—can provide a promising stabilization approach to achieving and sustaining fusion conditions in Z-pinch configurations. For example, the velocity at the center of the Z-pinch plasma may range from about 20 km/s to about 150 km/s, while the velocity at the edge of the Z-pinch plasma may range from about 80 km/s to 150 km/s or may be as low as −20 km/s to 20 km/s. One of the keys to unlocking the potential of sheared-flow-stabilized Z-pinch fusion devices as these devices are scaled up in power input—and thus in power output—is to mitigate, circumvent, or otherwise control instabilities, turbulence, heat transfer, and other factors limiting plasma lifetime. This is because once the reaction becomes unstable, the pinch ceases, neutron production stops, and power generation shuts down. Researchers have theorized that fusion conditions resulting in viable net power output that can be met at high power input are achievable when the flow shear exceeds a certain threshold above which the Z-pinch is stable, this threshold depending on the magnetic field strength and the plasma density. It is appreciated that the theory, instrumentation, implementation, and operation of conventional sheared-flow-stabilized Z-pinch plasma confinement devices are generally known in the art and need not be described in detail herein other than to facilitate an understanding of the present techniques. Reference is made in this regard to International Patent Application PCT/US2018/019364 (published as WO 2018/156860) as well as the following doctoral dissertation: Golingo, Raymond, Formation of a Sheared Flow Z-Pinch (University of Washington, 2003). The contents of these two documents are incorporated herein by reference in their entirety.

It is appreciated that establishing a sheared flow in a Z-pinch plasma can be a challenging process. In a conventional approach, a sheared flow is generated due to the velocity profile of the plasma as it exits the acceleration region and enters the assembly region, where it is compressed into the Z-pinch plasma. This approach to establishing a sheared flow poses challenges because the velocity profile tends to be nearly constant across the inner portion of the Z-pinch, with the shear being confined to in a thin region at the outer edge. Efforts to change the profile with different shapes at the end of the inner electrode have generally not produced significant velocity changes.

In contrast, the present techniques generate a multilayer plasma made up a plurality of radially arranged plasma layers with different velocity profiles, which can subsequently be injected inside the compression region of a Z-pinch device. The present techniques can allow for the plasma formation and shearing process to be controlled independently from the Z-pinch plasma compression process. In turn, independent control over these two processes can provide enhanced control over Z-pinch parameters and properties (e.g., plasma density, temperature, velocity, magnetic field, flow shear, and the like). In particular, controlled plasma injection and flow shearing can allow for a stable Z-pinch plasma to provide higher fusion power gain sustained over longer periods of time, with reduced or better controlled power losses and other energy inefficiencies.

It is noted, however, that the present techniques are not limited for use as plasma sources in sheared-flow-stabilized Z-pinch-based fusion reactors. As noted above, the present techniques can be implemented in a wide range of applications that may need or benefit from a plasma generator or source capable of providing a multilayer plasma with or without an embedded sheared flow. For example, in large and/or high-power pulsed plasma thrusters, using conventional single-channel coaxial plasma guns may be a challenge or drawback. This is because in order to achieve high power levels, it may be necessary to increase (i) the length and width of the single plasma channel to provide a high volume and high current plasma (which leads to larger electrodes and insulators), (ii) the size and the power capabilities of the power supply system (e.g., trigger system, high-voltage switch, capacitor bank). Furthermore, increasing the radial distance between the inner and outer electrodes can lead to larger inductance and lower peak current values. As a result, the size and weight of pulsed plasma thrusters based on single-channel coaxial plasma guns may become unacceptably or undesirably large in order to provide high power levels. In some embodiments, the present techniques can provide multichannel pulsed plasma thrusters that can be operated at reduced applied voltage and with reduced inductance to achieve higher efficiency and exhaust plasma speed.

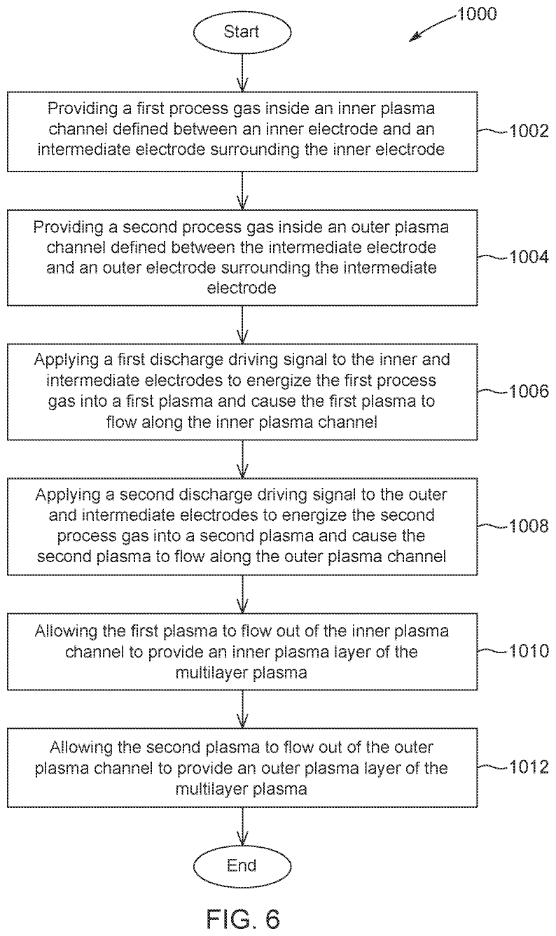

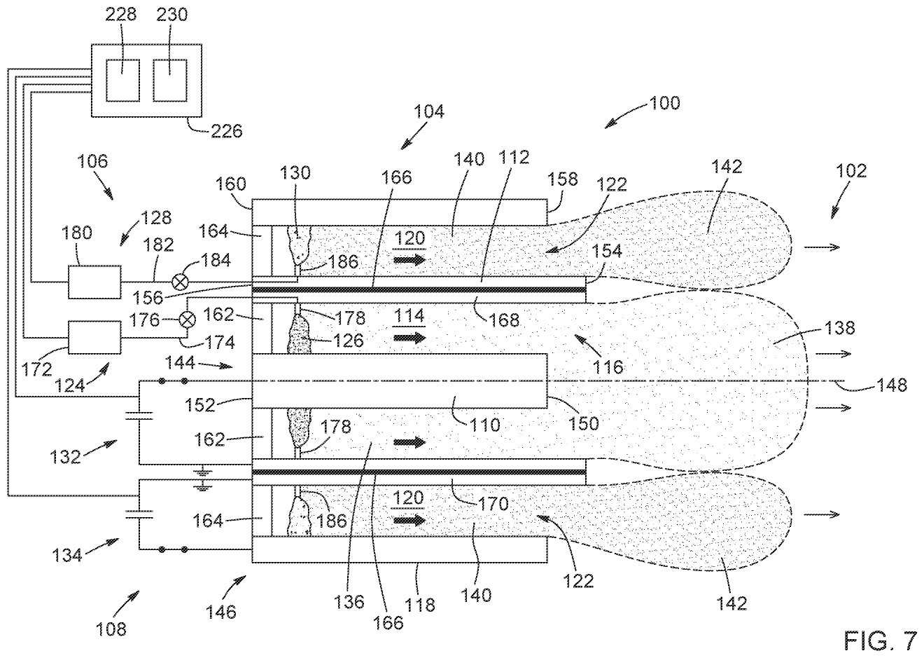

Referring to FIG. 6, there is illustrated a flow diagram of an embodiment of a method 1000 of generating a multilayer plasma for use, for example, in nuclear fusion power generation. The method 1000 of FIG. 6 may be implemented in a plasma generation system 100 such as the ones depicted in FIGS. 7 to 12, or another suitable plasma generation system. Broadly described, the method 1000 can include a step 1002 of providing a first process gas inside an inner plasma channel defined between an inner electrode and an intermediate electrode surrounding the inner electrode, and a step 1004 of providing a second process gas inside an outer plasma channel defined between the intermediate electrode and an outer electrode surrounding the intermediate electrode. The method 1000 can also include a step 1006 of applying a first discharge driving signal to the inner electrode and the intermediate electrode to energize the first process gas into a first plasma and cause the first plasma to flow along the inner plasma channel, and a step 1008 of applying a second discharge driving signal to the outer electrode and the intermediate electrode to energize the second process gas into a second plasma and cause the second plasma to flow along the outer plasma channel. The method 1000 can also further include a step 1010 of allowing the first plasma to flow out of the inner plasma channel to provide an inner plasma layer of the multilayer plasma, and a step 1012 of allowing the second plasma to flow out of the outer plasma channel to provide an outer plasma layer of the multilayer plasma.

Referring to FIGS. 6 and 7, there are illustrated a schematic longitudinal cross-sectional view (FIG. 6) and a schematic front cross-sectional view (FIG. 7) of a multichannel plasma generation system 100 for generating a multilayer plasma 102, in accordance with an embodiment. In the illustrated embodiment, the plasma generation system 100 is a double-channel system configured to generate the multilayer plasma 102 as a double-layer plasma. The plasma generation system 100 generally includes a plasma generator 104, a process gas unit 106, and a power supply unit 108.

The plasma generator 104 includes an inner electrode 110 and an intermediate electrode 112 surrounding the inner electrode 110 and defining therebetween an inner plasma channel 114 having an inner plasma outlet or exhaust 116. The plasma generator 104 also includes an outer electrode 118 surrounding the intermediate electrode 112 and defining therebetween an outer plasma channel 120 having an outer plasma outlet or exhaust 122.

The process gas unit 106 includes a first process gas system 124 configured to provide a first process gas 126 inside the inner plasma channel 114. The process gas unit 106 also includes a second process gas system 128 configured to provide a second process gas 130 inside the outer plasma channel 120. In some embodiments, the first process gas system 124 and the second process gas system 128 can be gas-puff systems.

The power supply unit 108 includes a first power supply system 132 and a second power supply system 134. The term “power supply” refers herein to any device or combination of devices configured to supply electrical power into a form usable by another device or combination of devices. The first power supply system 132 is configured to apply a first discharge driving signal to the inner electrode 110 and the intermediate electrode 112 to energize the first process gas 126 into a first plasma 136 and cause the first plasma 136 to flow along the inner plasma channel 114 and exit through the inner plasma outlet 116 to provide an inner plasma layer 138 of the multilayer plasma 102. The second power supply system 134 is configured to apply a second discharge driving signal to the outer electrode 118 and the intermediate electrode 112 to energize the second process gas 130 into a second plasma 140 and cause the second plasma 140 to flow along the outer plasma channel 120 and exit through the outer plasma outlet 122 to provide an outer plasma layer 142 of the multilayer plasma 102. In the illustrated embodiment, the inner electrode 110, the intermediate electrode 112 (inner section), the first process gas system 124, and the first power supply system 132 can be said to form an inner plasma gun 144 of the plasma generation system 100, while the outer electrode 118, the intermediate electrode 112 (outer section), the second process gas system 128, and the second power supply system 134 can be said to form an outer plasma gun 146 of the plasma generation system 100.

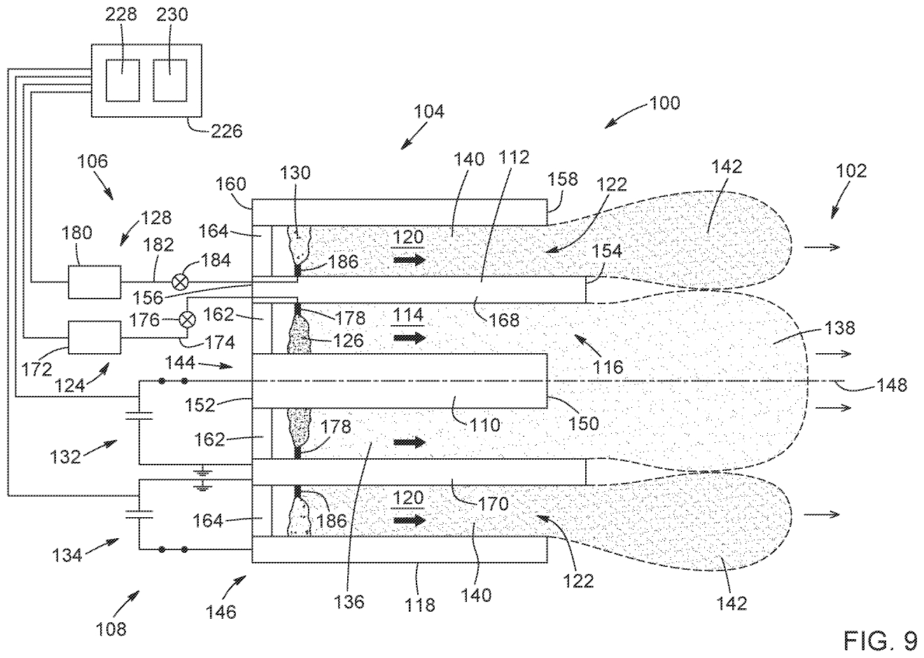

More details regarding the structure, configuration, and operation of these components and other possible components of the plasma generation system 100 are provided below. It is appreciated that FIGS. 6 and 7 are simplified schematic representations that illustrate certain features and components of the plasma generation system 100, such that additional features and components that may be useful or necessary for its practical operation may not be specifically depicted, and likewise for FIGS. 9 to 12 described below. Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), temperature control devices, operation monitoring and diagnostic devices (e.g., sensors), processors and controllers, and other types of hardware and equipment.

The plasma generator 104 generally extends along a longitudinal axis 148, along which the first plasma 136 and the second plasma 140 are accelerated prior to being ejected from the plasma generator 104 via the inner plasma outlet 116 and the outer plasma outlet 122, respectively. In the illustrated embodiment, the inner electrode 110, the intermediate electrode 112, and the outer electrode 118 each have an elongated configuration along the longitudinal axis 148. As used herein, the terms “longitudinal” and “axial” generally refer to a direction parallel to the longitudinal axis 148, while the terms “radial” and “transverse” generally refer to a direction that lies in a plane perpendicular to the longitudinal axis 148. The inner electrode 110 has a front end 150 and a rear end 152, the intermediate electrode 112 has a front end 154 and a rear end 156, and the outer electrode 118 has a front end 158 and a rear end 160. In the illustrated embodiment, the front end 154 of the intermediate electrode 112 extends forwardly beyond (i.e., longitudinally ahead) the front end 150 of the inner electrode 110 and the front end 158 of the outer electrode 118, as such an arrangement can help separate the inner and outer plasma layers 138, 142 from each other as they exit the plasma generator 104. However, various other arrangements of the front ends 150, 154, 158 of the electrodes 110, 112, 118 are possible in other embodiments.

In the illustrated embodiment, the inner electrode 110, the intermediate electrode 112, and the outer electrode 118 each have a substantially cylindrical configuration, with a circular cross-section transverse to the longitudinal axis 148. Depending on the application, the inner electrode 110 may have a full or hollow configuration. In the illustrated embodiment, the outer electrode 118 coaxially encloses the intermediate electrode 112, and the intermediate electrode 112 coaxially encloses the inner electrode 110. However, various other electrode configurations can be used in other embodiments. Non-limiting examples include, to name a few, non-coaxial arrangements and non-circularly symmetric transverse cross-sections.

The inner electrode 110, the intermediate electrode 112, and the outer electrode 118 may each be made of any suitable electrically conductive material, such as various metals and metal alloys. Non-limiting examples include, to name a few, tungsten-coated copper and graphite. In some embodiments, the inner electrode 110 can have a length ranging from about a few millimeters to about a few meters, and a radius ranging from about a few millimeters to about a few meters. In some embodiments, the intermediate electrode 112 can have a length ranging from about a few millimeters to about a few meters, a radius ranging from about a few millimeters to about a few meters, and a wall thickness ranging from about a few millimeters to about a few centimeters. In some embodiments, the outer electrode 118 can have a length ranging from about a few millimeters to about a few meters, a radius ranging from about a few millimeters to about a few meters, and a wall thickness ranging from about a few millimeters to about a few centimeters. Other electrode dimensions can be used in other embodiments. Depending on the application, the inner electrode 110, the intermediate electrode 112, and the outer electrode 118 may be of varying sizes, shapes, compositions, and configurations.

Referring still to FIGS. 6 and 7, the plasma generator 104 can include an inner electrode insulator 162 disposed between the inner electrode 110 and the intermediate electrode 112 at the rear ends 152, 156 thereof. The inner electrode insulator 162 is configured to provide electrical insulation between the inner electrode 110 and the intermediate electrode 112. The plasma generator 104 can also include an outer electrode insulator 164 disposed between the intermediate electrode 112 and the outer electrode 118 at the rear ends 156, 160 thereof. The outer electrode insulator 164 is configured to provide electrical insulation between the intermediate electrode 112 and the outer electrode 118. In the illustrated embodiment, both the inner electrode insulator 162 and the outer electrode insulator 164 have an annular cross-sectional shape, but other insulator shapes are possible in other embodiments. In the illustrated embodiment, the inner plasma channel 114 has a closed rear end defined by the inner electrode insulator 162, and an open front end defined by the inner plasma outlet 116. Similarly, the outer plasma channel 120 has a closed rear end defined by the outer electrode insulator 164 and an open front end defined by the outer plasma outlet 122.

In some embodiments, the plasma generator 104 can further include an intermediate electrode insulator 166 inserted between an inner electrode section 168 and an outer electrode section 170 of the intermediate electrode 112. The intermediate electrode insulator 166 is configured to provide electrical insulation between the inner electrode section 168 and the outer electrode section 170 of the intermediate electrode 112. In some embodiments, the intermediate electrode insulator 166 may be embodied by a tubular insulator sleeve or insert interposed between the inner electrode section 168 and the outer electrode section 170 of the intermediate electrode 112. The provision of the intermediate electrode insulator 166 can allow the inner plasma gun 144 and the outer plasma gun 146 to be operated independently from each other.

However, in other embodiments, the intermediate electrode insulator 166 may be omitted, as depicted as in the embodiment of FIG. 9. In such a case, the operation of the inner plasma gun 144 and the operation of the outer plasma gun 146 may not be independent from each other from an electrical standpoint. This is because when no intermediate electrode insulator is provided the intermediate electrode 112, which is part of both the inner plasma gun 144 and the outer plasma gun 146, is operated at a single voltage level, rather than two voltage levels.

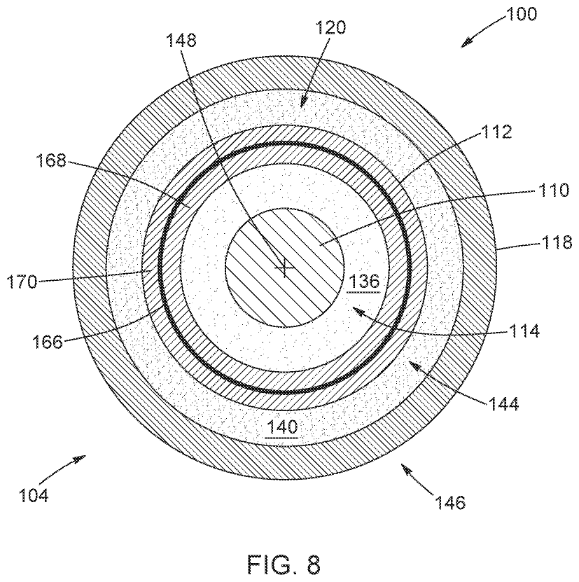

Returning to FIGS. 7 and 8, the inner, outer, and intermediate electrode insulators 162, 164, 166 can each be made of any suitable electrically insulating material. Non-limiting examples of such possible materials include glass materials, ceramic materials, glass-ceramic materials, and polymer materials. More specific examples of possible materials include, to name a few, alumina, boron nitride, borosilicate glass, porcelain, quartz, polytetrafluoroethylene (PTFE), MACOR®, and Teflon®. Depending on the application, the inner, outer, and intermediate electrode insulators 162, 164, 166 can each be of varying sizes, shapes, compositions, locations, and configurations.

In the illustrated embodiment, the inner plasma channel 114 has a substantially annular cross-sectional shape defined by the cross-sectional shapes of the inner electrode 110 and the intermediate electrode 112, while the outer plasma channel 120 has a substantially annular cross-sectional shape defined by the cross-sectional shapes of the intermediate electrode 112 and the outer electrode 118. The inner plasma channel 114 is configured to receive the first process gas 126 from the first process gas system 124, and the outer plasma channel 120 is configured to receive the second process gas 130 from the second process gas system 128.

The first process gas 126 and the second process gas 130 can each be composed of any suitable gas or gas mixture capable of being energized into the first plasma 136 and the second plasma 140 by the first power supply system 132 and the second power supply system 134, respectively. In fusion applications, the first process gas 126 and the second process gas 130 can include fusion reactants, such as deuterium, tritium, hydrogen, helium, or mixtures thereof (e.g., a deuterium-tritium mixture), or any other suitable fusion fuel. In thruster applications, the first process gas 126 and the second process gas 130 can include propellant gases, such as xenon, krypton, argon, or mixtures thereof. Other non-limiting examples of gases that can be used as the first process gas 126 and the second process gas 130 include, to name a few, neon and methane. Depending on the application, the first process gas 126 and the second process gas 130 may or may not have the same composition and/or properties. Depending on the application, the first process gas 126 and the second process gas 130 may each be a neutral gas, a partially ionized gas, or a fully ionized gas (e.g., a precursor plasma, for example, a low-temperature plasma, which can be further energized to form the first plasma 136 and/or the second plasma 140).

In the illustrated embodiment, the first process gas system 124 is configured to supply the first process gas 126 into the inner plasma channel 114 for the first process gas 126 to be energized into the first plasma 136 upon application of the first discharge driving signal to the inner electrode 110 and the intermediate electrode 112 by the first power supply system 132. Similarly, the second process gas system 128 is configured to supply the second process gas 130 into the outer plasma channel 120 for the second process gas 130 to be energized into the second plasma 140 upon application of the second discharge driving signal to the outer electrode 118 and the intermediate electrode 112 by the second power supply system 134.

The first process gas system 124 can include or be coupled to a first gas source 172 configured to store the first process gas 126. The first gas source 172 can be embodied by gas storage tank or any suitable pressurized gas dispensing container. The first process gas system 124 can also include a first gas supply line 174 connected between the first gas source 172 and the inner plasma channel 114 to allow the first process gas 126 to enter into the inner plasma channel 114. The first process gas system 124 can further include a first gas supply valve 176 configured to control a flow of the first process gas 126 along the first gas supply line 174, from the first gas source 172 to the inner plasma channel 114. The first gas supply valve 176 may be embodied by a variety of electrically actuated valves, such as a solenoid valve. The first gas supply line 174 terminates into the inner plasma channel 114 via one or more first gas injection ports 178 formed through the inner electrode 110 and/or the intermediate electrode 112. The second process gas system 128 can be similar to the first process gas system 124 in that it can include a second gas source 180, a second gas supply line 182, a second gas supply valve 184, and one or more second gas injection ports 186 formed through the outer electrode 118 and/or the intermediate electrode 112.

Various configurations and arrangements are contemplated for the first process gas system 124 and the second process gas system 128, which may or may not be identical to each other, and that various gas injection techniques can be used. For example, in some embodiments, the first process gas system 124 and the second process gas system 128 may share the same gas source and/or part of the same gas supply line. Furthermore, the first process gas system 124 and the second process gas system 128 may each include various additional flow control devices (e.g., valves, pumps, regulators, and restrictors; not shown) configured to control the introduction of the first and second process gases 126, 130 inside the inner and outer plasma channels 114, 120, respectively. The gas injection ports 178, 186 may, but need not, be located closer to the rear ends 152, 156, 160 of the inner, intermediate, and outer electrodes 110, 112, 118. In some embodiments, such an arrangement can increase the effective length of the inner and outer plasma channels 114, 120 along which the first and second plasmas 136, 140 are accelerated prior to being ejected via the inner and outer plasma outlets 116, 122.

In some embodiments, either or both of the first and second process gas systems 124, 128 may not include gas supply lines 174, 182 configured to supply the first and second process gases 126, 130 from external gas sources 172, 180 to the inner and outer plasma channels 114, 120 via gas injection ports 178, 186 formed through one or more the electrodes 110, 112, 118. For example, in some embodiments, either or both of the first and second process gas systems 124, 128 may be configured to provide the first and second process gases 126, 130 inside the inner and outer plasma channel 114, 120 via a sputtering process that does not involve the use of an external gas supply and injection system.

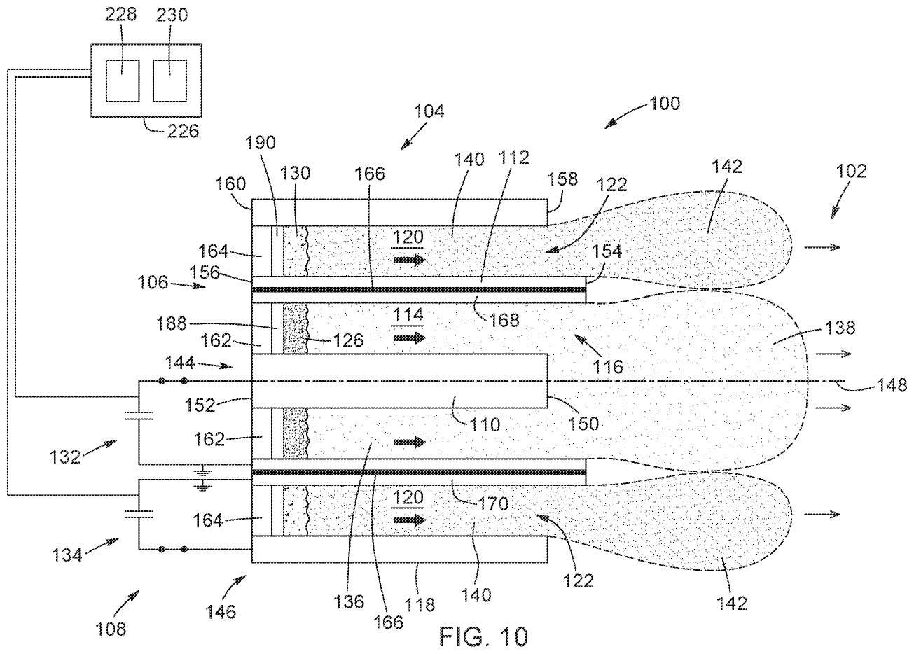

Such an embodiment of a plasma generation system 100 is illustrated in FIG. 10. This embodiment shares several features with the embodiment of FIGS. 7 and 8, which will not be described again other than to highlight differences between them. In the plasma generation system 100 of FIG. 10, the first process gas system 124 includes a first process gas precursor target 188 disposed inside the inner plasma channel 114, and the second process gas system 128 includes a second process gas precursor target 190 disposed inside the outer plasma channel 120. The first process gas system 124 is configured to generate the first process gas 126 inside the inner plasma channel 114 by sputtering of the first process gas precursor target 188. The sputtering of the first process gas precursor target 188 results in material ejection from the surface of the first process gas precursor target 188 as a vapor, where the vapor provides the first process gas 126. Similarly, the second process gas system 128 is configured to generate the second process gas 130 inside the outer plasma channel 120 by sputtering of the second process gas precursor target 190. The sputtering of the second process gas precursor target 190 results in material ejection from the surface of the second process gas precursor target 190 as a vapor, where the vapor provides the second process gas 130. The sputtering of the first and second precursor targets 188, 190 can be achieved in several ways. In some embodiments, high-voltage triggering sparks (e.g., produced by applying a voltage between triggering pins (not shown) provided inside the plasma channels 114, 120) can sputter the process gas precursor targets 188, 190 to generate the first and second process gases 126, 130. Non-limiting examples of target material for the process gas precursor targets 188, 190 includes an electrically insulating material such as, to name a few, PTFE, Teflon®, and other similar materials. In some embodiments, the first and second process gas precursor targets 188, 190 may be provided by the inner and outer electrode insulators 162, 164, respectively.

Returning to FIGS. 7 and 8, in the illustrated embodiment, the first power supply system 132 is configured to apply the first discharge driving signal to the inner electrode 110 and the inner electrode section 168 of the intermediate electrode 112 so as to create a first discharge voltage radially across the inner plasma channel 114 to ionize the first process gas 126 into the first plasma 136. The first plasma 136 allows electric current to flow radially therethrough between the inner electrode 110 and the inner electrode section 168. The electric current that flows axially along the inner electrode 110 and the inner electrode section 168 generates an azimuthal magnetic field inside the inner plasma channel 114. The interaction between the radial electric current flowing in the first plasma 136 and the azimuthal magnetic field produces a Lorentz force in the axial direction that causes the first plasma 136 to propagate and be accelerated axially forward along the inner plasma channel 114 as an annular plasma column. Upon reaching the end of the inner plasma channel 114, which defines an inner exhaust region, the first plasma 136 is ejected from the plasma generator 104 via the inner plasma outlet 116 to provide the inner plasma layer 138 of the multilayer plasma 102.

Similarly, the second power supply system 134 is configured to apply the second discharge driving signal to the outer electrode 118 and the outer electrode section 170 of the intermediate electrode 112 so as to create a second discharge voltage radially across the outer plasma channel 120 to ionize the second process gas 130 into the second plasma 140. The second plasma 140 allows electric current to flow radially therethrough between the outer electrode 118 and the outer electrode section 170. The electric current that flows axially along the outer electrode 118 and the outer electrode section 170 generates an azimuthal magnetic field inside the outer plasma channel 120. The interaction between the radial electric current flowing in the second plasma 140 and the azimuthal magnetic field produces a Lorentz force in the axial direction that causes the second plasma 140 to propagate and be accelerated axially forward along the outer plasma channel 120 as an annular plasma column. Upon reaching the end of the outer plasma channel 120, which defines an outer exhaust region, the second plasma 140 is ejected from the plasma generator 104 via the outer plasma outlet 122 to provide the outer plasma layer 142 of the multilayer plasma 102.

In some embodiments, both the inner electrode section 168 and the outer electrode section 170 of the intermediate electrode 112 may be grounded to either the same ground or different grounds. In other embodiments, either or both of the inner electrode 110 and the outer electrode 118 may be grounded. It is appreciated that various circuit, electrode polarity, and ground configurations are contemplated.

In some embodiments, the first power supply system 132 and the second power supply system 134 can each include a pulsed-DC power supply including an energy storage bank (e.g., a capacitor bank, a Marx generator, or a linear transformer driver), a switch (e.g., a spark gap, a rail-gap switch, an ignitron, or a semiconductor switch), and a pulse forming network (including, e.g., inductors, resistors, diodes, and the like). Other suitable types of power supplies may be used in other embodiments, including DC power supplies, such as DC grids, voltage source converters, and homopolar generators. Depending on the application, the first power supply system 132 and the second power supply system 134 may be voltage-controlled or current-controlled. In some embodiments, each of the first and second discharge driving signal can be a voltage pulse having a peak magnitude ranging from about 500 V to about 5 MV, a half-cycle pulse duration ranging from about 100 ns to about 1 s, and a peak current amplitude ranging from about 1 A to about 10 MA, although other peak magnitude voltage values, other pulse duration values, and other peak current amplitudes may be used in other embodiments. It is appreciated that the instrumentation, implementation, and operation of power supplies used in plasma generation systems are generally known in the art and need not be described in greater detail herein.

In some embodiments, the first power supply system 132 and the second power supply system 134 may be operated independently from each other (e.g., with separate grounds and/or floating potentials) to provide individual control over the first and second discharge driving signals (e.g., in terms of magnitude, polarity, and/or waveform). In some embodiments, the first and second discharge driving signals may be adjusted to control the properties of the first and second plasmas 136, 140, respectively. The control over the first and second plasmas 136, 140 can in turn provide enhanced control over the properties of the inner and outer plasma layers 138, 142 of the multilayer plasma 102 (e.g., plasma density, temperature, velocity, and magnetic field) and over how these properties vary as a function of position, including as a function of radial position, within the multilayer plasma 102. Depending on the application, the first and second discharge driving signals may or may not be identical to each other. The operation of the first power supply system 132 and the second power supply system 134 may be selected in view of the configuration and operating conditions of the plasma generator 104 in order to favor the ionization of the first and second process gases 126, 130 into the first and second plasmas 136, 140, and the acceleration of the first and second plasmas 136, 140 along and out of the inner and outer plasma channels 114, 120.

It is appreciated that, in some embodiments, the process of operating the inner plasma gun 144 to form the inner plasma layer 138 of the multilayer plasma 102 can be largely or entirely decoupled from the process of operating the outer plasma gun 146 to form the outer plasma layer 142. In particular, by independently adjusting the operating parameters of the inner plasma gun 144 and those of the outer plasma gun 146, the properties of the inner plasma layer 138 and those of the outer plasma layer 142 can be individually controlled. Non-limiting examples of operating parameters include discharge parameters such as the discharge voltages (e.g., in terms of magnitude, polarity, and waveform) applied by the first and second power supply systems 132, 134; the composition, pressure, and injection rate of the first and second process gases 126, 130 supplied by the first and second process gas systems 124, 128; and the configurations and dimensions of the inner and outer plasma channels 114, 120. Non-limiting examples of properties of the inner and outer plasma layers 138, 142 that can be individually controlled include, to name a few, the plasma temperature, density, velocity, and magnetic field. For example, in some embodiments, the operating parameters of the inner and outer plasma guns 144, 146 can be adjusted to generate a multilayer plasma 102 having a high-density, high-temperature, and low-velocity inner plasma layer 138, and a low-density, low-temperature, and high-velocity outer plasma layer 142, or vice versa. In some embodiments, the operation of the inner and outer plasma guns 144, 146 can be adjusted to generate a multilayer plasma 102 having an embedded radially sheared axial flow, wherein the axial velocity of the inner plasma layer 138 is different from the axial velocity of the outer plasma layer 142. However, in other embodiments, the multilayer plasma 102 may be generated without a radial velocity shear (e.g., with a purely axial flow).

In some embodiments, the operation of applying the first and second discharge driving signals can be initiated after initiating the operation of supplying the first and second process gases 126, 130 into the inner and outer plasma channels 114, 120. In some embodiments, the time delay between initiating the application of the first and second discharge driving signals and initiating the supply of the first and second process gases 126, 130 into the inner and outer plasma channels 114, 120 can range between about 1 ns and about 100 ms. In other embodiments, the operation of applying the first and second discharge driving signals can be initiated at the same time as or before initiating the operation of supplying the first and second process gases 126, 130 into the inner and outer plasma channels 114, 120. In some embodiments, the provision of the first process gas 126 inside the inner plasma channel 114 and the provision of the second process gas 130 inside the outer plasma channel 120 can be initiated at the same time, and likewise for the application of the first discharge driving signal and the application of the second discharge driving signal. In other embodiments, there may be a time offset between the start-up time of the inner plasma gun 144 and the start-up time of the outer plasma gun 146, for example, if the application of the first and second discharge driving signals and/or the supply of the first and second process gases 126, 130 are initiated at different times.

It is appreciated that the inner and outer plasma outlets 116, 122 can have different configurations to provide individual control over the exhaust speeds of the inner and outer plasma layers 138, 142. For example, in some embodiments, either or both of the inner and outer plasma outlets 116, 122 may include an exhaust nozzle, for example, a magnetic nozzle, to achieve this exhaust speed control.

Referring still to FIGS. 7 and 8, the multilayer plasma 102 generated by the plasma generation system 100 can be used, processed, or coupled to another device or system in a variety of ways depending on the application. For example, in some embodiments, the multilayer plasma 102 may be used as a source of plasma for injection into a plasma-based fusion reactor. For example, in some implementations, the multilayer plasma 102 may be generated with an embedded radially sheared axial flow for injection inside a compression region for compression into a sheared-flow-stabilized Z-pinch plasma at fusion conditions. Reference is made in this regard to International Patent Application PCT/US2022/012502, filed Jan. 14, 2022 and published as WO 2022/155462 on Jul. 21, 2022.

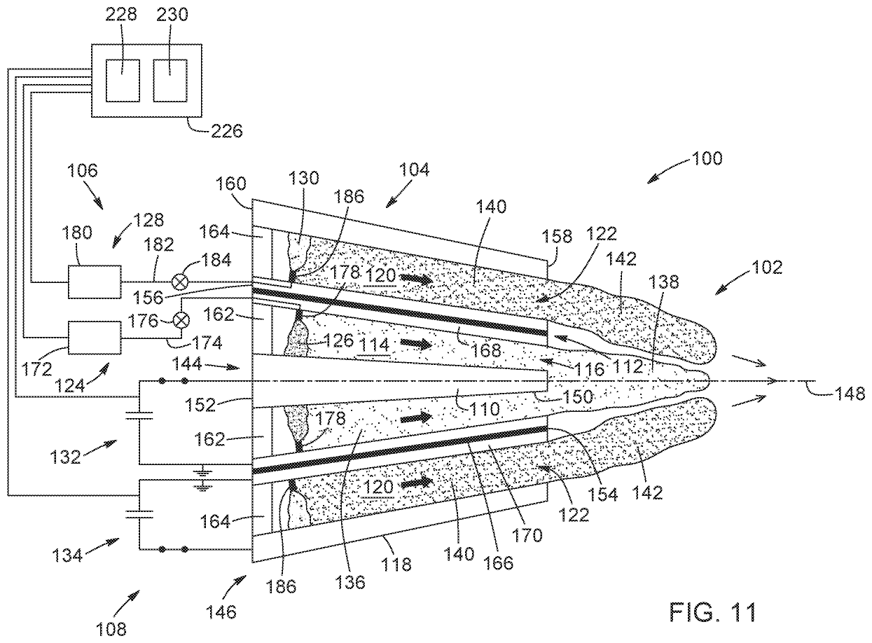

In other embodiments, the multilayer plasma 102 may be exhausted out of the plasma generation system 100, for example, to provide a source of thrust in pulsed plasma thrusters and space propulsion applications (e.g., nano satellites, satellites, and space missions). In such embodiments, the first and second process gases 126, 130 can be propellant gases, such as xenon, krypton, argon, or mixtures thereof. In some embodiments, the present techniques can provide multichannel pulsed plasma thrusters that can operate without dedicated gas supply or puff systems. In such embodiments, the first and second process gas systems 124, 128 may be configured to provide the first and second process gases 126, 130 from vapors produced by particles sputtered from first and second process gas precursor targets 188, 190 provided inside the inner and outer plasma channels 114, 120 (see, e.g., FIG. 11).

In other embodiments, the multilayer plasma may be used in tokamak fusion reactors, field-reversed-configuration (FRC) fusion reactors (e.g., based on colliding beams), pulsed plasma thrusters, and other types of plasma-based fusion reactors.

Referring to FIG. 11, there is illustrated a schematic longitudinal cross-sectional view of another embodiment of a multichannel plasma generation system 100 configured to generate a multilayer plasma 102. The plasma generation system 100 illustrated in FIG. 11 shares several features with the embodiment of FIGS. 7 and 8, which will not be described again in detail other than to highlight differences between them. In contrast to the embodiment of FIGS. 7 and 8, the plasma generation system 100 of FIG. 11 has a tapered configuration, in which each of the inner electrode 110, the intermediate electrode 112, and the outer electrode 118 tapers radially inwardly at a tapering angle from its rear end 152, 156, 160 to its front end 150, 154, 158 (i.e., moving in a direction toward the inner and outer plasma outlets 116, 122). Depending on the application, the electrodes 110, 112, 118 may or may not all have the same tapering angle. The provision of a tapered configuration can allow the multilayer plasma 102 to be exhausted as a more focused plasma beam. Such an arrangement can be required or useful in certain applications, for example, to produce double-layer pinches and multi-stage pinch configurations in pinch-based devices such as dense plasma focus and Z-pinch devices. It is appreciated that while the inner, intermediate, and outer electrodes 110, 112, 118 are all tapered in the embodiment of FIG. 11, other embodiments can provide only one or two of the three electrodes 110, 112, 118 with a tapered configuration.

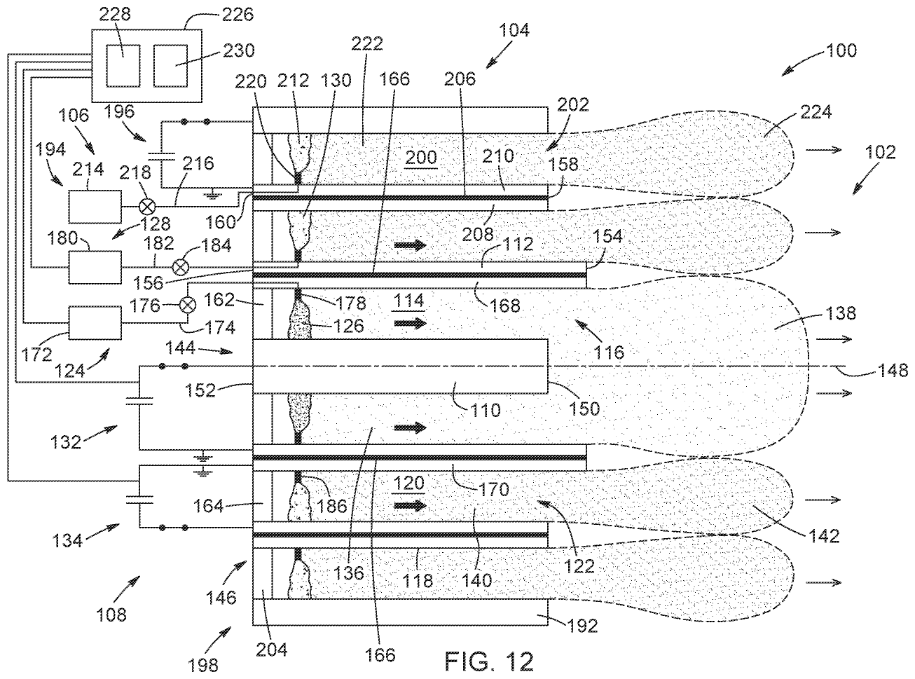

It is appreciated that although several embodiments described above relate to double-channel plasma generation systems configured to generate double-layer plasmas, other embodiments can be used to generate multilayer plasmas having three or more plasma layers, where the properties and parameters of the three or more layers can be controlled independently from one another. Referring to FIG. 12, there is illustrated a schematic longitudinal cross-sectional view of an embodiment of triple-layer plasma generation system 100 configured to generate a three-layer plasma 102. The plasma generation system 100 illustrated in FIG. 12 shares several features with the embodiment of FIGS. 7 and 8, which will not be described again in detail other than to highlight differences between them. In FIG. 12, the plasma generator 104 includes an additional electrode 192, the process gas unit 106 includes an additional process gas system 194, and the power supply unit 108 includes an additional power supply system 196. The inner electrode 110, the intermediate electrode 112 (inner section), the first process gas system 124, and the first power supply system 132 can be said to form an inner plasma gun 144, the outer electrode 118 (inner section), the intermediate electrode 112 (outer section), the second process gas system 128, and the second power supply system 134 can be said to form an outer plasma gun 146, and the outer electrode 118 (outer section), the additional electrode 192, the additional process gas system 194, and the additional power supply system 196 can be said to form an additional plasma gun 198.

The additional electrode 192 surrounds the outer electrode 118 and defines therebetween an additional plasma channel 200 having an additional plasma outlet 202. In some embodiments, the plasma generator 104 can include a first additional electrode insulator 204 disposed between the outer electrode 118 and the additional electrode 192. The first additional electrode insulator 204 is configured to provide electrical insulation between the outer electrode 118 and the additional electrode 192. In the illustrated embodiment, the additional plasma channel 200 has a closed rear end defined by the first additional electrode insulator 204, and an open front end defined by the additional plasma outlet 202. In some embodiments, the plasma generator 104 can also include a second additional electrode insulator 206 inserted between an inner electrode section 208 and an outer electrode section 210 of the outer electrode 118. The second additional electrode insulator 206 is configured to provide electrical insulation between the inner electrode section 208 and the outer electrode section 210 of the outer electrode 118. The provision of the intermediate electrode insulator 166 can allow the outer plasma gun 146 and the additional plasma gun 198 to be operated independently from each other.

The additional process gas system 194 is configured to provide an additional process gas 212 inside the additional plasma channel 200. The additional process gas system 194 can include or be coupled to an additional gas source 214 configured to store the additional process gas 212, an additional gas supply line 216 connected between the additional gas source 214 and the additional plasma channel 200 to allow the additional process gas 212 to enter into the additional plasma channel 200, and an additional gas supply valve 218 configured to control a flow of the additional process gas 212 along the additional gas supply line 216. The additional gas supply line 216 terminates into the additional plasma channel 200 via one or more additional gas injection ports 220 formed through the outer electrode 118 and/or the additional electrode 192.

The additional power supply system 196 is configured supply power to apply an additional discharge driving signal to the outer electrode 118 and the additional electrode 192 to energize the additional process gas 212 into an additional plasma 222 and cause the additional plasma 222 to flow along and out of the additional plasma channel 200 through the additional plasma outlet 202 to provide an additional plasma layer 224 of the multilayer plasma 102, the additional plasma layer 224 surrounding the outer plasma layer 142.

It is appreciated that while the plasma generation system 100 depicted in FIG. 12 includes three-channel, the extension to multichannel plasma generation systems having more than three channels is straightforward and is contemplated by the present techniques.

In some embodiments, including those illustrated in FIGS. 7 to 12, the plasma generation system 100 may include a vacuum system (not shown). The vacuum system may include a vacuum chamber, for example, a pressure vessel or tank (e.g., made of stainless steel). The vacuum chamber may be configured to contain, at least in part, various components of the plasma generation system 100, for example, at least part of the electrodes 110, 112, 118 of the plasma generator 104. The vacuum system may also include a pressure control system configured to control the operating pressure inside the vacuum chamber. In some embodiments, the pressure inside the vacuum chamber may range from about 10⁻⁹ Torr to about 20 Torr, although other pressure ranges may be used in other embodiments.

Returning to FIG. 7, the plasma generation system 100 can further include a control and processing unit 226 configured to control, monitor, and/or coordinate the functions and operations of various system components (e.g., the process gas unit 106 and the power supply unit 108), as well as various operating conditions (e.g., temperature, pressure, flow rate, and power conditions). The control and processing unit 226 can be implemented in hardware, software, firmware, or any combination thereof, and may be connected to various components of the plasma generation system 100 via wired and/or wireless communication links to send and/or receive various types of signals (e.g., timing and control signals, measurement signals, and data signals). The control and processing unit 226 may be controlled by direct user input and/or by programmed instructions, and may include an operating system for controlling and managing various functions of the plasma generation system 100. Depending on the application, the control and processing unit 226 may be fully or partly integrated with, or physically separate from, the other hardware components of the plasma generation system 100. The control and processing unit 226 can include a processor 228 and a memory 230.

The processor 228 can implement operating systems, and may be able to execute computer programs, also known as commands, instructions, functions, processes, software codes, executables, applications, and the like. While the processor 228 is depicted in FIG. 7 as a single entity for illustrative purposes, the term “processor” should not be construed as being limited to a single processing entity, and accordingly, any known processor architecture may be used. In some embodiments, the processor 228 may include a plurality of processing entities. Such processing entities may be physically located within the same device, or the processor 228 may represent the processing functionalities of a plurality of devices operating in coordination. For example, the processor 228 may include or be part of one or more of a computer; a microprocessor; a microcontroller; a coprocessor; a central processing unit (CPU); a special-purpose programmable logic device embodied in hardware device, such as, for example, a field-programmable gate array (FPGA) or an application-specific integrated circuit (ASIC); a digital processor; an analog processor; and/or other mechanisms configured to electronically process information and to operate collectively as a processor.

The memory 230, which may also be referred to as a “computer readable storage medium” or a “computer readable memory” is configured to store computer programs and other data to be retrieved by the processor 228. The terms “computer readable storage medium” and “computer readable memory” refer herein to a non-transitory and tangible computer product that can store and communicate executable instructions for the implementation of various steps of the techniques disclosed herein. The memory 230 may be any computer data storage device or assembly of such devices, including a random-access memory (RAM); a dynamic RAM; a read-only memory (ROM); a magnetic storage device; an optical storage device; a flash drive memory; and/or any other non-transitory memory technologies. The memory 230 may be associated with, coupled to, or included in the processor 228, and the processor 228 may be configured to execute instructions contained in a computer program stored in the memory 230 and relating to various functions and operations associated with the processor 228. While the memory 230 is depicted in FIG. 7 as a single entity for illustrative purposes, the term “memory” should not be construed as being limited to a single memory unit, and accordingly, any known memory architecture may be used. In some embodiments, the memory 230 may include a plurality of memory units. Such memory units may be physically located within the same device, or the memory 230 can represent the functionalities of a plurality of devices operating in coordination.

The plasma generation system 100 may also include one or more user interface devices (not shown) operatively connected to the control and processing unit 226 to allow the input of commands and queries to the plasma generation system 100, as well as present the outcomes of the commands and queries. The user interface devices can include input devices (e.g., a touch screen, a keypad, a keyboard, a mouse, a switch, and the like) and output devices (e.g., a display screen, a printer, visual and audible indicators and alerts, and the like).

The following aspects are also disclosed herein:

1. A plasma generation system for generating a multilayer plasma, the plasma generation system comprising:
a plasma generator comprising:
   an inner electrode;
   an intermediate electrode surrounding the inner electrode and defining therebetween an inner plasma channel having an inner plasma outlet; and
   an outer electrode surrounding the intermediate electrode and defining therebetween an outer plasma channel having an outer plasma outlet;
a process gas unit comprising:
   a first process gas system configured to provide a first process gas inside the inner plasma channel; and
   a second process gas system configured to provide a second process gas inside the outer plasma channel; and
a power supply unit comprising:
   a first power supply system configured to apply a first discharge driving signal to the inner electrode and the intermediate electrode to energize the first process gas into a first plasma and cause the first plasma to flow along the inner plasma channel and out through the inner plasma outlet to provide an inner plasma layer of the multilayer plasma; and
   a second power supply system configured to apply a second discharge driving signal to the outer electrode and the intermediate electrode to energize the second process gas into a second plasma and cause the second plasma to flow along the outer plasma channel and out through the outer plasma outlet to provide an outer plasma layer of the multilayer plasma.

2. The plasma generation system of aspect 1, wherein:
the plasma generator comprises an additional electrode surrounding the outer electrode and defining therebetween an additional plasma channel having an additional plasma outlet;
the process gas unit comprises an additional process gas system configured to provide an additional process gas inside the additional plasma channel; and
the power supply unit comprises an additional power supply system configured to apply an additional discharge driving signal to the outer electrode and the additional electrode to energize the additional process gas into an additional plasma and cause the additional plasma to flow along the additional plasma channel and out through the additional plasma outlet to provide an additional plasma layer of the multilayer plasma, the additional plasma layer surrounding the outer plasma layer.

3. The plasma generation system of aspect 1 or 2, wherein each of the inner electrode, the intermediate electrode, and the outer electrode tapers radially inwardly in a direction toward the inner and outer plasma outlets.

4. The plasma generation system of any one of aspects 1 to 3, wherein each of the first power supply system and the second power supply system comprises a pulsed-DC power supply having a capacitor bank and a switch.

5. The plasma generation system of any one of aspects 1 to 4, wherein the inner plasma layer and the outer plasma layer have different axial velocities to provide the multilayer plasma with an embedded radially sheared axial flow.

6. The plasma generation system of any one of aspects 1 to 4, wherein the inner plasma layer and the outer plasma layer have at least one of different densities, different temperatures, or different velocities.

7. The plasma generation system of any one of aspects 1 to 6, further comprising:
an intermediate electrode insulator configured to provide electrical insulation between an inner electrode section and an outer electrode section of the intermediate electrode,
wherein the first power supply system is configured to apply the first discharge driving signal to the inner electrode and the inner electrode section of the intermediate electrode,
wherein the second power supply system is configured to apply the second discharge driving signal to the outer electrode and the outer electrode section of the intermediate electrode.

8. The plasma generation system of any one of aspects 1 to 7, wherein each of the first process gas and the second process gas comprises deuterium, tritium, hydrogen, or helium, or any combination thereof.

9. The plasma generation system of any one of aspects 1 to 7, wherein each of the first process gas and the second process gas comprises xenon, krypton, argon, or mixtures thereof.

10. The plasma generation system of any one of aspects 1 to 9, wherein each of the first process gas and the second process gas is a neutral gas.

11. The plasma generation system of any one of aspects 1 to 10, wherein each of the first process gas and the second process gas is a partially or fully ionized gas.

12. The plasma generation system of any one of aspects 1 to 11, wherein:
the first process gas system is configured to supply the first process gas into the inner plasma channel via one or more first gas injection ports formed through the inner electrode, the intermediate electrode, or both the inner electrode and the intermediate electrode; and
the second process gas system is configured to supply the second process gas into the outer plasma channel via one or more second gas injection ports formed through the outer electrode, the intermediate electrode, or both the outer electrode and the intermediate electrode.

13. The plasma generation system of any one of aspects 1 to 11, wherein:
the first process gas system comprises a first process gas precursor target disposed inside the inner plasma channel, the first process gas system being configured to generate the first process gas inside the inner plasma channel by sputtering of the first process gas precursor target; and
the second process gas system comprises a second process gas precursor target disposed inside the outer plasma channel, the second process gas system being configured to generate the second process gas inside the outer plasma channel by sputtering of the second process gas precursor target.

14. A method of generating a multilayer plasma, the method comprising:
providing a first process gas inside an inner plasma channel defined between an inner electrode and an intermediate electrode surrounding the inner electrode;
providing a second process gas inside an outer plasma channel defined between the intermediate electrode and an outer electrode surrounding the intermediate electrode;
applying a first discharge driving signal to the inner electrode and the intermediate electrode to energize the first process gas into a first plasma and cause the first plasma to flow along the inner plasma channel;
applying a second discharge driving signal to the outer electrode and the intermediate electrode to energize the second process gas into a second plasma and cause the second plasma to flow along the outer plasma channel;
allowing the first plasma to flow out of the inner plasma channel to provide an inner plasma layer of the multilayer plasma; and
allowing the second plasma to flow out of the outer plasma channel to provide an outer plasma layer of the multilayer plasma.

15. The method of aspect 14, further comprising:
providing an additional process gas inside an additional plasma channel defined between the outer electrode and an additional electrode surrounding the outer electrode;
applying an additional discharge driving signal to the outer electrode and the additional electrode to energize the additional process gas into an additional plasma and cause the additional plasma to flow along the additional plasma channel; and
allowing the additional plasma to flow out of the additional plasma channel to provide an additional layer of the multilayer plasma, the additional plasma layer surrounding the outer plasma layer.

16. The method aspect 14 or 15, further comprising configuring each of the inner electrode, the intermediate electrode, and the outer electrode to taper radially inwardly in diameter along a direction toward the inner and outer plasma outlets.

17. The method any one of aspects 14 to 16, further comprising controlling the inner plasma layer and the outer plasma layer flowing out of the inner plasma channel and the outer plasma channel, respectively, to have different axial velocities to provide the multilayer plasma with an embedded radially sheared axial flow.

18. The method of any one of aspects 14 to 16, further comprising controlling the inner plasma layer and the outer plasma layer flowing out of the inner plasma channel and the outer plasma channel to have at least one of different densities, different temperatures, or different velocities.

19. The method of any one of aspects 14 to 18, further comprising providing an intermediate electrode insulator between an inner electrode section and an outer electrode section of the intermediate electrode, wherein the first discharge driving signal is applied to the inner electrode and the inner electrode section of the intermediate electrode, and wherein the second discharge driving signal is applied to the outer electrode and the outer electrode section of the intermediate electrode.

20. The method of any one of aspects 14 to 19, wherein each of the first process gas and the second process gas comprises deuterium, tritium, hydrogen, or helium, or any combination thereof.

21. The method of any one of aspects 14 to 19, wherein each of the first process gas and the second process gas comprises xenon, krypton, argon, or mixtures thereof.

22. The method of any one of aspects 14 to 21, wherein:
providing the first process gas inside an inner plasma channel comprises supplying the first process gas into the inner plasma channel via one or more first gas injection ports formed through the inner electrode, the intermediate electrode, or both the inner electrode and the intermediate electrode; and
providing the second process gas inside an outer plasma channel comprises supplying the second process gas into the outer plasma channel via one or more second gas injection ports formed through the outer electrode, the intermediate electrode, or both the outer electrode and the intermediate electrode.

23. The method of any one of aspects 14 to 21, wherein;
providing the first process gas inside the inner plasma channel comprises generating the first process gas by sputtering of a first process gas precursor target disposed inside the inner plasma channel; and
providing the second process gas inside the outer plasma channel comprises generating the second process gas by sputtering of a second process gas precursor target disposed inside the outer plasma channel.

24. The method of any one of aspects 14 to 23, wherein the application of the first discharge driving signal is initiated after initiating the provision of the first process gas inside the inner plasma channel, and wherein the application of the second discharge driving signal is initiated after initiating the provision of the second process gas inside the outer plasma channel.

25. The method of any one of aspects 14 to 24, wherein the provision of the first process gas inside the inner plasma channel and the provision of the second process gas inside the outer plasma channel are initiated at the same time, and wherein the application of the first discharge driving signal and the application of the second discharge driving signal are initiated at the same time.

Numerous modifications could be made to the embodiments described above without departing from the scope of the appended claims.

1. A plasma generation system for generating a multilayer plasma, the plasma generation system comprising:
a plasma generator comprising:
an inner electrode;
an intermediate electrode surrounding the inner electrode and defining therebetween an inner plasma channel having an inner plasma outlet; and
an outer electrode surrounding the intermediate electrode and defining therebetween an outer plasma channel having an outer plasma outlet;
a process gas unit comprising:
a first process gas system configured to provide a first process gas inside the inner plasma channel; and
a second process gas system configured to provide a second process gas inside the outer plasma channel; and
a power supply unit comprising:
a first power supply system configured to apply a first discharge driving signal to the inner electrode and the intermediate electrode to energize the first process gas into a first plasma and cause the first plasma to flow along the inner plasma channel and out through the inner plasma outlet to provide an inner plasma layer of the multilayer plasma; and
a second power supply system configured to apply a second discharge driving signal to the outer electrode and the intermediate electrode to energize the second process gas into a second plasma and cause the second plasma to flow along the outer plasma channel and out through the outer plasma outlet to provide an outer plasma layer of the multilayer plasma.

2. The plasma generation system of claim 1, wherein:
the plasma generator comprises an additional electrode surrounding the outer electrode and defining therebetween an additional plasma channel having an additional plasma outlet;
the process gas unit comprises an additional process gas system configured to provide an additional process gas inside the additional plasma channel; and
the power supply unit comprises an additional power supply system configured to apply an additional discharge driving signal to the outer electrode and the additional electrode to energize the additional process gas into an additional plasma and cause the additional plasma to flow along the additional plasma channel and out through the additional plasma outlet to provide an additional plasma layer of the multilayer plasma, the additional plasma layer surrounding the outer plasma layer.

3. The plasma generation system of claim 1, wherein each of the inner electrode, the intermediate electrode, and the outer electrode tapers radially inwardly in a direction toward the inner and outer plasma outlets.

4. The plasma generation system of claim 1, wherein each of the first power supply system and the second power supply system comprises a pulsed-DC power supply having a capacitor bank and a switch.

5. The plasma generation system of claim 1, wherein the inner plasma layer and the outer plasma layer have different axial velocities to provide the multilayer plasma with an embedded radially sheared axial flow.

6. The plasma generation system of claim 1, wherein the inner plasma layer and the outer plasma layer have at least one of different densities, different temperatures, or different velocities.

7. The plasma generation system of claim 1, further comprising:
an intermediate electrode insulator configured to provide electrical insulation between an inner electrode section and an outer electrode section of the intermediate electrode,
wherein the first power supply system is configured to apply the first discharge driving signal to the inner electrode and the inner electrode section of the intermediate electrode,
wherein the second power supply system is configured to apply the second discharge driving signal to the outer electrode and the outer electrode section of the intermediate electrode.

8. The plasma generation system of claim 1, wherein each of the first process gas and the second process gas comprises deuterium, tritium, hydrogen, or helium, or any combination thereof.

9. The plasma generation system of claim 1, wherein each of the first process gas and the second process gas comprises xenon, krypton, argon, or mixtures thereof.

10. The plasma generation system of claim 1, wherein each of the first process gas and the second process gas is a neutral gas.

11. The plasma generation system of claim 1, wherein each of the first process gas and the second process gas is a partially or fully ionized gas.

12. The plasma generation system of claim 1, wherein:
the first process gas system is configured to supply the first process gas into the inner plasma channel via one or more first gas injection ports formed through the inner electrode, the intermediate electrode, or both the inner electrode and the intermediate electrode; and
the second process gas system is configured to supply the second process gas into the outer plasma channel via one or more second gas injection ports formed through the outer electrode, the intermediate electrode, or both the outer electrode and the intermediate electrode.

13. The plasma generation system of claim 1, wherein:
the first process gas system comprises a first process gas precursor target disposed inside the inner plasma channel, the first process gas system being configured to generate the first process gas inside the inner plasma channel by sputtering of the first process gas precursor target; and
the second process gas system comprises a second process gas precursor target disposed inside the outer plasma channel, the second process gas system being configured to generate the second process gas inside the outer plasma channel by sputtering of the second process gas precursor target.

14. A method of generating a multilayer plasma, the method comprising:
providing a first process gas inside an inner plasma channel defined between an inner electrode and an intermediate electrode surrounding the inner electrode;
providing a second process gas inside an outer plasma channel defined between the intermediate electrode and an outer electrode surrounding the intermediate electrode;
applying a first discharge driving signal to the inner electrode and the intermediate electrode to energize the first process gas into a first plasma and cause the first plasma to flow along the inner plasma channel;
applying a second discharge driving signal to the outer electrode and the intermediate electrode to energize the second process gas into a second plasma and cause the second plasma to flow along the outer plasma channel;
allowing the first plasma to flow out of the inner plasma channel to provide an inner plasma layer of the multilayer plasma; and
allowing the second plasma to flow out of the outer plasma channel to provide an outer plasma layer of the multilayer plasma.

15. The method of claim 14, further comprising:
providing an additional process gas inside an additional plasma channel defined between the outer electrode and an additional electrode surrounding the outer electrode;
applying an additional discharge driving signal to the outer electrode and the additional electrode to energize the additional process gas into an additional plasma and cause the additional plasma to flow along the additional plasma channel; and
allowing the additional plasma to flow out of the additional plasma channel to provide an additional layer of the multilayer plasma, the additional plasma layer surrounding the outer plasma layer.

16. The method of claim 14, further comprising configuring each of the inner electrode, the intermediate electrode, and the outer electrode to taper radially inwardly in diameter along a direction toward the inner and outer plasma outlets.

17. The method of claim 14, further comprising controlling the inner plasma layer and the outer plasma layer flowing out of the inner plasma channel and the outer plasma channel, respectively, to have different axial velocities to provide the multilayer plasma with an embedded radially sheared axial flow.

18. The method of claim 14, further comprising controlling the inner plasma layer and the outer plasma layer flowing out of the inner plasma channel and the outer plasma channel to have at least one of different densities, different temperatures, or different velocities.

19. The method of claim 14, further comprising providing an intermediate electrode insulator between an inner electrode section and an outer electrode section of the intermediate electrode, wherein the first discharge driving signal is applied to the inner electrode and the inner electrode section of the intermediate electrode, and wherein the second discharge driving signal is applied to the outer electrode and the outer electrode section of the intermediate electrode.

20. The method of claim 14, wherein each of the first process gas and the second process gas comprises deuterium, tritium, hydrogen, or helium, or any combination thereof.

21. The method of claim 14, wherein each of the first process gas and the second process gas comprises xenon, krypton, argon, or mixtures thereof.

22. The method of claim 14, wherein:
providing the first process gas inside an inner plasma channel comprises supplying the first process gas into the inner plasma channel via one or more first gas injection ports formed through the inner electrode, the intermediate electrode, or both the inner electrode and the intermediate electrode; and
providing the second process gas inside an outer plasma channel comprises supplying the second process gas into the outer plasma channel via one or more second gas injection ports formed through the outer electrode, the intermediate electrode, or both the outer electrode and the intermediate electrode.

23. The method of claim 14, wherein:
providing the first process gas inside the inner plasma channel comprises generating the first process gas by sputtering of a first process gas precursor target disposed inside the inner plasma channel; and
providing the second process gas inside the outer plasma channel comprises generating the second process gas by sputtering of a second process gas precursor target disposed inside the outer plasma channel.

24. The method of claim 14, wherein the application of the first discharge driving signal is initiated after initiating the provision of the first process gas inside the inner plasma channel, and wherein the application of the second discharge driving signal is initiated after initiating the provision of the second process gas inside the outer plasma channel.

25. The method of claim 14, wherein the provision of the first process gas inside the inner plasma channel and the provision of the second process gas inside the outer plasma channel are initiated at the same time, and wherein the application of the first discharge driving signal and the application of the second discharge driving signal are initiated at the same time.
